(19) United States
(12) Patent Application Publication
(10) Pub. No.: US 2026/0245798 A1
(43) Pub. Date: Aug. 20, 2026

(54) CAPACITOR SHEET, CAPACITOR, AND ELECTRONIC COMPONENT INCLUDING THE SAME

(71) Applicant: TDK Corporation, Tokyo (JP)

(72) Inventors: Tatsuo NAMIKAWA, Tokyo (JP); Hiroyasu INOUE, Tokyo (JP); Hitoshi SAITA, Tokyo (JP)

(73) Assignee: TDK Corporation, Tokyo (JP)

(21) Appl. No.: 19/539,302

(22) Filed: Feb. 13, 2026

(30) Foreign Application Priority Data
Feb. 20, 2025 (JP) 2025-025756

(51) Int. Cl. H01G 4/232; H01G 4/012; H01G 4/12; H01G 4/248; H01G 4/30; H01G 4/33

(52) U.S. Cl. CPC H01G 4/232; H01G 4/012; H01G 4/1227; H01G 4/248; H01G 4/30; H01G 4/306; H01G 4/33

(57) ABSTRACT

In a capacitor sheet, a capacitor and an electronic component including the capacitor sheet, the capacitor sheet includes both a first through-hole portion and a second through-hole portion. When pressing from a vertical direction of the capacitor sheet, A resin from a first main surface side easily flows into the first through-hole portion, and a resin from a second main surface side easily flows into the second through-hole portion, hence, unevenness in the flow of the resin is less likely to occur, high positional accuracy can be realized, and high reliability can be realized.

### CROSS-REFERENCE TO RELATED APPLICATIONS

This application is based upon and claims the benefit of priority from Japanese Patent Application No. 2025-25756, filed on 20 February, 2025, the entire contents of which are incorporated herein by reference.

### TECHNICAL FIELD

The present disclosure relates to a capacitor sheet, a capacitor, and an electronic component including the same.

### BACKGROUND

Japanese Patent Application Publication No. 2021-136337 discloses a thin-film capacitor embedded in a circuit board. The thin-film capacitor is entirely covered with an insulating resin layer when incorporated into the circuit board, and the thin-film capacitor is provided with a through-hole for a via conductor extracted to the upper and lower surfaces of the circuit board to pass through.

### SUMMARY

When entirely covering the above-described thin-film capacitor with an insulating resin layer, resin may be arranged on the upper and lower sides of the thin-film capacitor and pressed from the vertical direction. At this time, if unevenness occurs in the flow of the resin, sufficient positional accuracy cannot be obtained, which may lead to a decrease in reliability.

According to various aspects of the present disclosure, a capacitor sheet with improved reliability, a capacitor and an electronic component including the same are provided.

A capacitor sheet according to one aspect of the present disclosure is a capacitor sheet having a first main surface and a second main surface. The capacitor sheet includes a capacitance portion having a dielectric layer, a first conductor located on the first main surface side, and a second conductor layer located on the second main surface side. The dielectric layer is interposed between the first conductor layer and the second conductor layer. The capacitor sheet includes a plurality of through-hole portions penetrating the capacitance portion. The plurality of through-hole portions include a first through-hole portion and a second through-hole portion. In the first through-hole portion, an opening dimension of the first conductor layer, an opening dimension of the dielectric layer, and an opening dimension of the second conductor layer decrease in this order. In the second through-hole portion, the opening dimension of the first conductor layer, the opening dimension of the dielectric layer, and the opening dimension of the second conductor layer increase in this order.

A capacitor according to one aspect of the present disclosure includes the above capacitor sheet and a resin covering the first main surface and the second main surface of the capacitor sheet.

An electronic component according to one aspect of the present disclosure has the above capacitor mounted thereon.

### BRIEF DESCRIPTION OF THE DRAWINGS

FIG. 1 is a schematic cross-sectional view showing an electronic component according to an embodiment.

FIG. 2 is a schematic cross-sectional view showing a capacitor sheet of the electronic component shown in FIG. 1.

FIG. 3 is an enlarged view of a main part of the capacitor sheet shown in FIG. 2.

FIG. 4 is an enlarged view of a main part of the capacitor sheet shown in FIG. 2.

FIG. 5 is a flowchart including steps for manufacturing the capacitor shown in FIG. 1.

FIG. 6 is a diagram showing one step of the capacitor manufacturing method shown in FIG. 5.

FIG. 7 is a diagram showing one step of the capacitor manufacturing method shown in FIG. 5.

FIG. 8 is a diagram showing one step of the capacitor manufacturing method shown in FIG. 5.

FIG. 9 is a diagram showing one step of the capacitor manufacturing method shown in FIG. 5.

FIG. 10 is a diagram showing one step of the capacitor manufacturing method shown in FIG. 5.

### DETAILED DESCRIPTION

Hereinafter, embodiments of the present disclosure will be described in detail with reference to the accompanying drawings. In the description of the drawings, the same or corresponding elements are denoted by the same reference numerals, and redundant description thereof will be omitted.

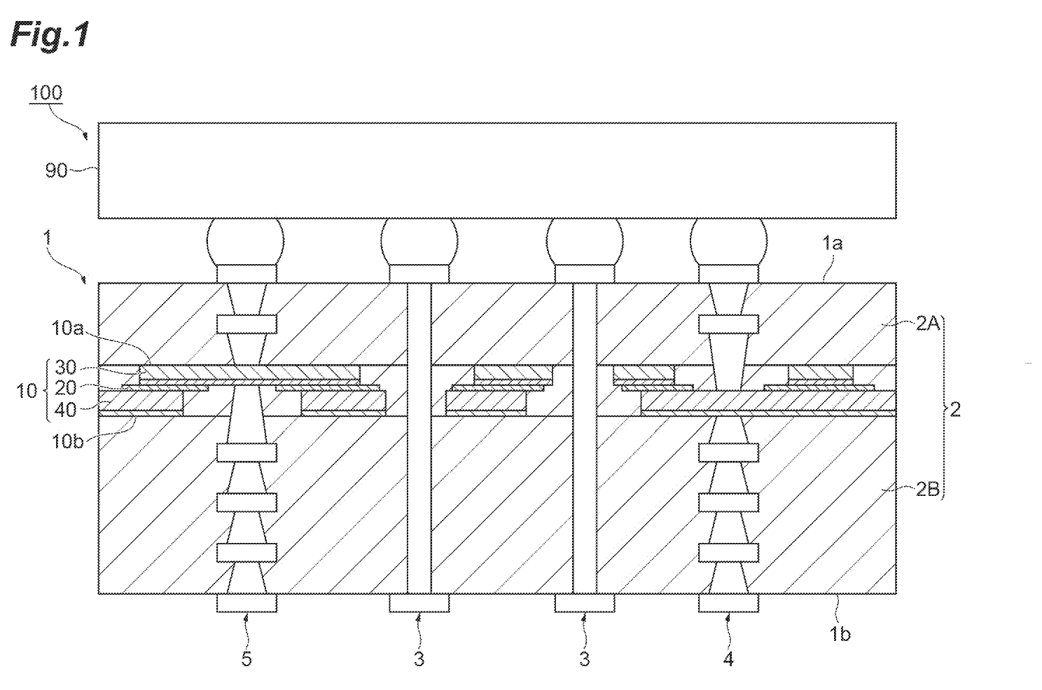

A capacitor 1 according to an embodiment will be described with reference to FIGS. 1 to 4. The capacitor 1 is a type of circuit board and has a flexible sheet-like or plate-like shape. The capacitor 1 according to the present embodiment has, for example, a rectangular sheet shape of 180 mm × 180 mm. The capacitor 1 has a pair of main surfaces 1a and 1b that face each other in the thickness direction.

The pair of main surfaces 1a and 1b of the capacitor 1 are both composed of a resin 2. A plurality of terminals are provided on each of the pair of main surfaces 1a and 1b, and via conductors 3 to 5 extending from these terminals into the resin 2 are provided.

A CPU 90 is mounted on the main surface 1a of the capacitor 1 via terminals provided on the main surface 1a, and an electronic component 100 including the capacitor 1 and the CPU 90 is configured. In the present embodiment, the CPU 90 is mounted on the capacitor 1 via solder bumps.

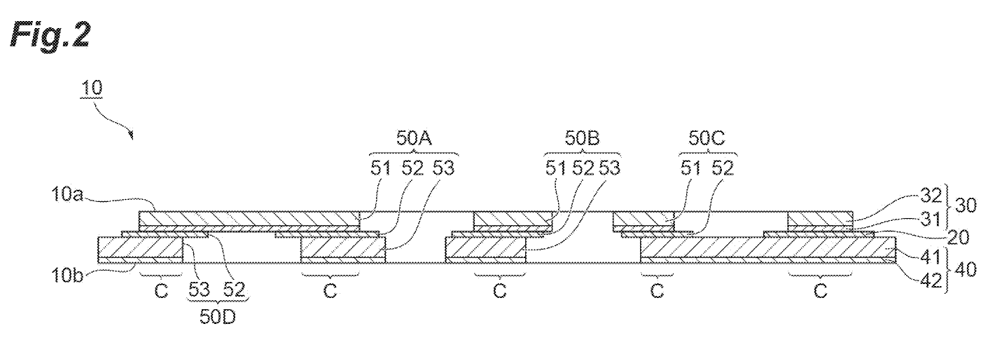

The capacitor 1 incorporates a capacitor sheet 10. As shown in FIG. 2, the capacitor sheet 10 has a sheet-like shape and has a thickness of, for example, 50 μm or less (40 μm as an example). The capacitor sheet 10 has a pair of main surfaces 10a and 10b that face each other in the thickness direction of the capacitor 1. One main surface 10a is located on the main surface 1a side of the capacitor 1 and is covered with a resin 2A, which is a part of the resin 2, from the main surface 1a side of the capacitor 1. Similarly, the other main surface 10b is located on the main surface 1b side of the capacitor 1 and is covered with a resin 2B, which is a part of the resin 2, from the main surface 1b side of the capacitor 1. Hereinafter, for convenience of description, one main surface 10a of the capacitor sheet 10 is also referred to as a first main surface, and the other main surface 10b is also referred to as a second main surface. The resin 2 can be composed of, for example, a polyimide-based resin or an epoxy-based resin. The resin 2 may include a filler, and silica can be used as the filler.

The capacitor sheet 10 is configured to include a dielectric layer 20, a first conductor layer 30, and a second conductor layer 40. Specifically, the capacitor sheet 10 has a laminated structure in which the dielectric layer 20 is sandwiched between the first conductor layer 30 and the second conductor layer 40 in the facing direction of the pair of main surfaces 10a and 10b. With respect to the dielectric layer 20, the first conductor layer 30 is located on the first main surface 10a side, and the second conductor layer 40 is located on the second main surface 10b side. The capacitor sheet 10 constitutes a capacitance portion C in a region where the dielectric layer 20, the first conductor layer 30, and the second conductor layer 40 are laminated.

The dielectric layer 20 has a thickness of, for example, 0.1 to 10.0 μm (0.3 μm as an example), and may be configured with a sputtered layer of a ceramic dielectric (barium titanate as an example).

The first conductor layer 30 has a thickness of, for example, 0.1 to 50 μm (20 μm as an example). In the present embodiment, the first conductor layer 30 is composed of two layers: an Ni layer 31 and a Cu layer 32. The Ni layer 31 may be a sputtered layer (for example, with a thickness of 0.5 μm) formed on the dielectric layer 20, and the Cu layer 32 may be a plated layer (for example, with a thickness of 19.5 μm) formed on the Ni layer 31. Note that the first conductor layer 30 may be configured with a single layer or with three or more layers.

The second conductor layer 40 has a thickness of, for example, 1.0 to 50 μm (19.7 μm as an example). In the present embodiment, the second conductor layer 40 is composed of two layers: an Ni layer 41 and a Cu layer 42. The Ni layer 41 may be an Ni foil (for example, with a thickness of 14 μm) that functions as a substrate on which the dielectric layer 20 is formed, or may be an Ni-based alloy foil. The Cu layer 42 may be a plated layer (for example, with a thickness of 5 μm) formed on the Ni layer 41. Note that the second conductor layer 40 may be configured with a single layer or with three or more layers.

The capacitor sheet 10 is provided with a plurality of through-hole portions 50A and 50B and a plurality of recessed portions 50C and 50D. In the present embodiment, the capacitor sheet 10 provided with two through-hole portions 50A and 50B is shown, but the number of through-hole portions can be increased as appropriate.

Each of the plurality of through-hole portions 50A and 50B is configured with an opening edge 51 of the first conductor layer 30, an opening edge 52 of the dielectric layer 20, and an opening edge 53 of the second conductor layer 40. In the present embodiment, each of the through-hole portions 50A and 50B has a perfect circular cross-section, and the opening edges 51, 52, and 53 have concentric perfect circular cross-sections. The cross-sectional view of FIG. 2 shows a cross-section extending along the facing direction of the first main surface 10a and the second main surface 10b of the capacitor sheet 10 and passing through the centers of the through-hole portions 50A and 50B, and the width of the through-hole portions 50A and 50B in FIG. 2 corresponds to the diameter of the through-hole portions 50A and 50B.

The plurality of through-hole portions 50A and 50B are configured to include a first through-hole portion 50A and a second through-hole portion 50B.

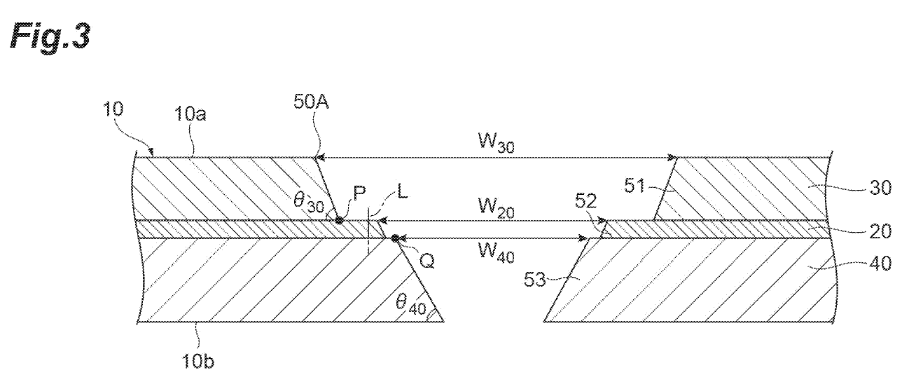

In the first through-hole portion 50A, as shown in FIG. 3, a width W₃₀ (opening dimension, opening diameter) of the opening edge 51 of the first conductor layer 30, a width W₂₀ of the opening edge 52 of the dielectric layer 20, and a width W₄₀ of the opening edge 53 of the second conductor layer 40 are different from each other. More specifically, the width W₃₀of the opening edge 51 of the first conductor layer 30, the width W₂₀ of the opening edge 52 of the dielectric layer 20, and the width W₄₀ of the opening edge 53 of the second conductor layer 40 decrease in this order (W₃₀ > W₂₀ > W₄₀). In the first through-hole portion 50A, the width W₃₀ of the opening edge 51 of the first conductor layer 30 is, for example, 100 to 5000 μm (300 μm as an example), the width W₂₀ of the opening edge 52 of the dielectric layer 20 is, for example, 100 to 5000 μm (200 μm as an example), and the width W₄₀ of the opening edge 53 of the second conductor layer 40 is, for example, 100 to 5000 μm (100 μm as an example).

Regarding the end of the opening edge 52 of the dielectric layer 20, it protrudes from an end P of the opening edge 51 of the first conductor layer 30 in the extending direction of the dielectric layer 20. The protruding length of the end of the opening edge 52 of the dielectric layer 20 is longer than the thickness of the dielectric layer 20. In the present embodiment, the end of the opening edge 52 of the dielectric layer 20 extends beyond a middle position L between the end P of the opening edge 51 of the first conductor layer 30 and an end Q of the opening edge 53 of the second conductor layer 40, and is biased toward the opening edge 53 side of the second conductor layer 40. Since the end of the opening edge 52 of the dielectric layer 20 protrudes from the end P of the opening edge 51 of the first conductor layer 30 in this way, a creepage distance between the first conductor layer 30 and the second conductor layer 40 is extended, so that a short circuit between the conductor layers is further suppressed. Since a longer creepage distance between the first conductor layer 30 and the second conductor layer 40 suppresses a short circuit between the conductor layers, when the end of the opening edge 52 of the dielectric layer 20 extends beyond the middle position L and is biased toward the opening edge 53 side of the second conductor layer 40, high insulation between the conductor layers is realized.

In the present embodiment, each of the opening edges 51, 52, and 53 in the first through-hole portion 50A is inclined so as to become narrower as it approaches the second main surface 10b. In this case, the widths W₃₀, W₂₀, and W₄₀ of the opening edges 51, 52, and 53 can be defined as the maximum width (the width at the height position closest to the first main surface 10a). In the present embodiment, an inclination angle θ₃₀ of the opening edge 51 of the first conductor layer 30 is different from an inclination angle θ₄₀ of the opening edge 53 of the second conductor layer 40. Specifically, the inclination angle θ₄₀ of the opening edge 53 of the second conductor layer 40 is designed to be smaller than the inclination angle θ₃₀ of the opening edge 51 of the first conductor layer 30 (θ₃₀> θ₄₀). In the first through-hole portion 50A, the inclination angle θ₃₀ of the opening edge 51 of the first conductor layer 30 is, for example, 45 to 90° (80° as an example), and the inclination angle θ₄₀ of the opening edge 53 of the second conductor layer 40 is, for example, 30 to 90° (60° as an example). In the present embodiment, the inclination angle of the opening edge 52 of the dielectric layer 20 in the first through-hole portion 50A is smaller than the inclination angle θ₃₀ of the opening edge 51 of the first conductor layer 30 and the inclination angle θ₄₀ of the opening edge 53 of the second conductor layer 40.

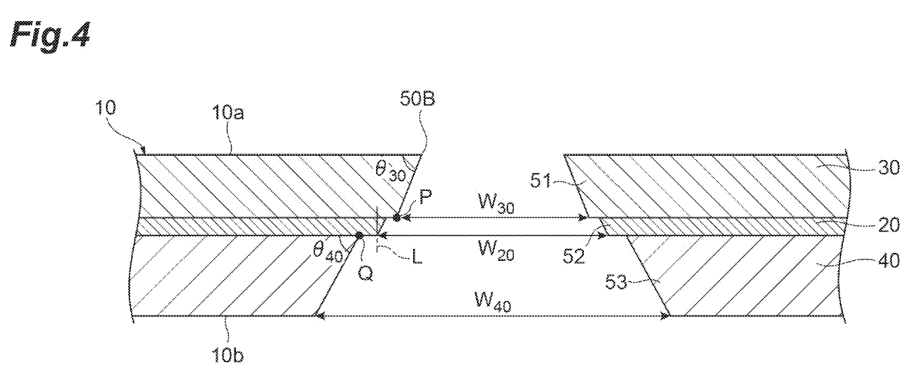

Also in the second through-hole portion 50B, as shown in FIG. 4, a width W₃₀ of the opening edge 51 of the first conductor layer 30, a width W₂₀ of the opening edge 52 of the dielectric layer 20, and a width W₄₀ of the opening edge 53 of the second conductor layer 40 are different from each other. In the second through-hole portion 50B, contrary to the first through-hole portion 50A, the width W₃₀ of the opening edge 51 of the first conductor layer 30, the width W₂₀ of the opening edge 52 of the dielectric layer 20, and the width W₄₀ of the opening edge 53 of the second conductor layer 40 increase in this order (W₄₀ > W₂₀ > W₃₀). In the second through-hole portion 50B, the width W₃₀ of the opening edge 51 of the first conductor layer 30 is, for example, 100 to 5000 μm (100 μm as an example), the width W₂₀ of the opening edge 52 of the dielectric layer 20 is, for example, 100 to 5000 μm (200 μm as an example), and the width W₄₀ of the opening edge 53 of the second conductor layer 40 is, for example, 100 to 5000 μm (300 μm as an example).

Regarding the end of the opening edge 52 of the dielectric layer 20, the end of the opening edge 52 of the dielectric layer 20 protrudes from an end Q of the opening edge 53 of the second conductor layer 40 in the extending direction of the dielectric layer 20. The protruding length of the end of the opening edge 52 of the dielectric layer 20 is longer than the thickness of the dielectric layer 20. In the present embodiment, the end of the opening edge 52 of the dielectric layer 20 extends beyond a middle position L between the end P of the opening edge 51 of the first conductor layer 30 and the end Q of the opening edge 53 of the second conductor layer 40, and is biased toward the opening edge 51 side of the first conductor layer 30. Since the end of the opening edge 52 of the dielectric layer 20 protrudes from the end Q of the opening edge 53 of the second conductor layer 40 in this way, a creepage distance between the first conductor layer 30 and the second conductor layer 40 is extended, so that a short circuit between the conductor layers is further suppressed. Since a longer creepage distance between the first conductor layer 30 and the second conductor layer 40 suppresses a short circuit between the conductor layers, when the end of the opening edge 52 of the dielectric layer 20 extends beyond the middle position L and is biased toward the opening edge 51 side of the first conductor layer 30, high insulation between the conductor layers is realized.

In the present embodiment, each of the opening edges 51, 52, and 53 in the second through-hole portion 50B is inclined so as to become narrower as it approaches the first main surface 10a. In this case, the widths W₃₀, W₂₀, and W₄₀ of the opening edges 51, 52, and 53 can be defined as the maximum width (the width at the height position closest to the second main surface 10b). In the present embodiment, an inclination angle θ₃₀ of the opening edge 51 of the first conductor layer 30 is different from an inclination angle θ₄₀ of the opening edge 53 of the second conductor layer 40. Specifically, the inclination angle θ₄₀ of the opening edge 53 of the second conductor layer 40 is designed to be smaller than the inclination angle θ₃₀ of the opening edge 51 of the first conductor layer 30 (θ₃₀ > θ₄₀). In the second through-hole portion 50B, the inclination angle θ₃₀ of the opening edge 51 of the first conductor layer 30 is, for example, 45 to 90° (80° as an example), and the inclination angle θ₄₀ of the opening edge 53 of the second conductor layer 40 is, for example, 30 to 90° (60° as an example). In the present embodiment, the inclination angle of the opening edge 52 of the dielectric layer 20 in the second through-hole portion 50B is smaller than the inclination angle θ₃₀of the opening edge 51 of the first conductor layer 30 and the inclination angle θ₄₀ of the opening edge 53 of the second conductor layer 40.

As shown in FIG. 1, a via conductor 3 extending between the pair of main surfaces 1a and 1b of the capacitor 1 passes through the above-described first through-hole portion 50A and second through-hole portion 50B. A resin 2 is interposed between the first through-hole portion 50A and the via conductor 3, and they are electrically insulated from each other. Similarly, a resin 2 is interposed between the second through-hole portion 50B and the via conductor 3, and they are electrically insulated from each other.

Among the plurality of recessed portions 50C and 50D provided in the capacitor sheet 10, the recessed portion 50C is configured with the opening edge 51 of the first conductor layer 30 and the opening edge 52 of the dielectric layer 20, and the recessed portion 50D is configured with the opening edge 52 of the dielectric layer 20 and the opening edge 53 of the second conductor layer 40. In the present embodiment, the recessed portion 50C has a perfect circular cross-section, and the opening edges 51 and 52 have concentric perfect circular cross-sections. Further, the recessed portion 50D has a perfect circular cross-section, and the opening edges 52 and 53 have concentric perfect circular cross-sections.

In the recessed portion 50C, the width of the opening edge 52 of the dielectric layer 20 is narrower than the width of the opening edge 51 of the first conductor layer 30, and the end of the opening edge 52 of the dielectric layer 20 protrudes from the end of the opening edge 51 of the first conductor layer 30. On the other hand, in the recessed portion 50D, the width of the opening edge 52 of the dielectric layer 20 is narrower than the width of the opening edge 53 of the second conductor layer 40, and the end of the opening edge 52 of the dielectric layer 20 protrudes from the end of the opening edge 53 of the second conductor layer 40.

In the recessed portion 50C, as shown in FIG. 1, a via conductor 4 extending between the pair of main surfaces 1a and 1b of the capacitor 1 is connected to the second conductor layer 40, and they are electrically conducted to each other. Similarly, in the recessed portion 50D, a via conductor 5 extending between the pair of main surfaces 1a and 1b of the capacitor 1 is connected to the first conductor layer 30, and they are electrically conducted to each other.

In the capacitor 1, the via conductor 3 has no electrical involvement with the capacitance portion C of the capacitor sheet 10 and passes through the resin 2 of the capacitor 1 as, for example, a separate power supply line. The via conductor 4 is connected to the first conductor layer 30 of the capacitor sheet 10 and functions as a capacitor power supply line. Similarly, the via conductor 5 is also connected to the second conductor layer 40 of the capacitor sheet 10 and functions as a capacitor power supply line.

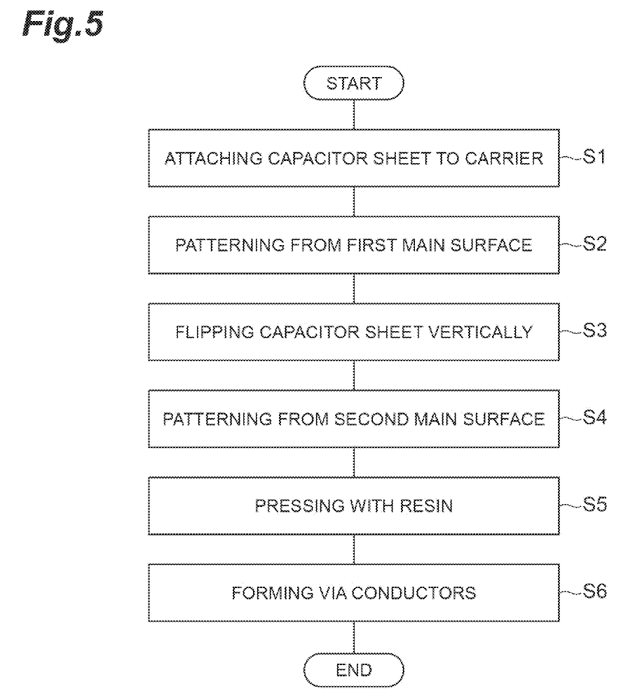

Next, a manufacturing method for manufacturing the above-described capacitor 1 will be described with reference to FIGS. 5 to 10. FIG. 5 is a flowchart including steps for manufacturing the capacitor 1.

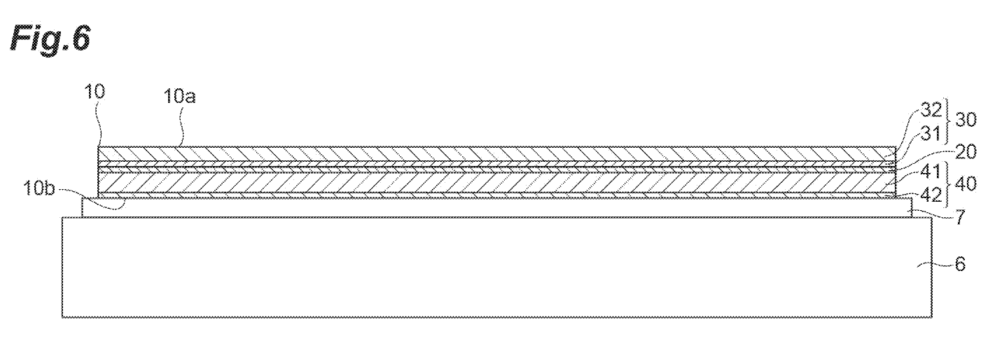

When manufacturing the capacitor 1, first, as step S1, as shown in FIG. 6, a capacitor sheet 10 in which the through-hole portions 50A and 50B and the plurality of recessed portions 50C and 50D are not provided (that is, a sheet-like laminate of the dielectric layer 20, the first conductor layer 30, and the second conductor layer 40) is attached onto a predetermined carrier 6 (for example, a glass epoxy substrate) via a release sheet 7 (for example, a heat-foamable sheet).

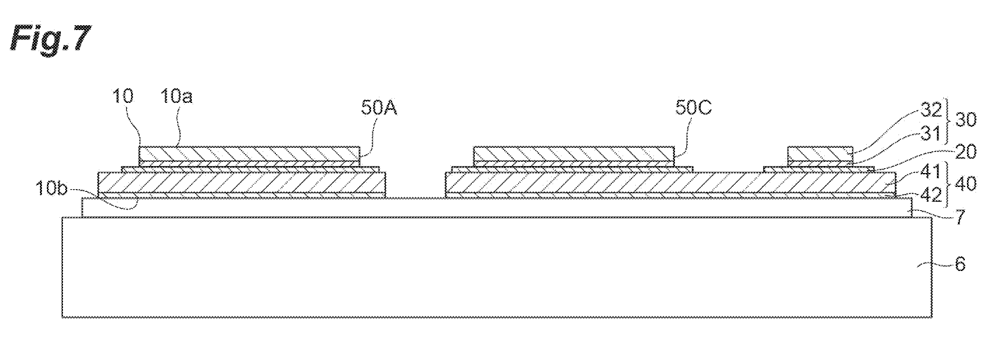

Next, as step S2, as shown in FIG. 7, patterning is performed from the first main surface 10a side by a known photolithography technique and wet etching process to form the first through-hole portion 50A and the recessed portion 50C. The patterning for forming the first through-hole portion 50A is performed in three separate steps in the order of patterning of the first conductor layer 30, patterning of the dielectric layer 20, and patterning of the second conductor layer 40. The patterning for forming the recessed portion 50C is performed in two separate steps: patterning of the first conductor layer 30 and patterning of the dielectric layer 20. At this time, the shape and dimensions of the opening edges are mainly determined by the mask shape, and the inclination angles of the opening edges of the first conductor layer 30, the dielectric layer 20, and the second conductor layer 40 are mainly determined by the etching conditions and layer materials. For example, the inclination angle of the opening edge of the first conductor layer 30, whose main constituent material is Cu which is relatively easy to etch, is larger than the inclination angle of the opening edge of the second conductor layer 40, whose main constituent material is Ni which is more difficult to etch than Cu.

The patterning of the first conductor layer 30 of the first through-hole portion 50A and the patterning of the first conductor layer 30 of the recessed portion 50C can be performed simultaneously, and the patterning of the dielectric layer 20 of the first through-hole portion 50A can be performed simultaneously with the patterning of the dielectric layer 20 of the recessed portion 50C.

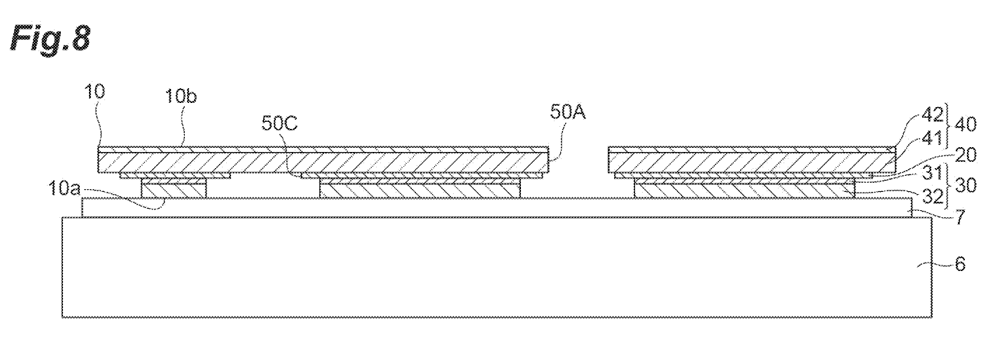

The capacitor sheet 10, which has been patterned from the first main surface 10a side, is peeled off from the carrier 6, and as shown in FIG. 8, as step S3, the capacitor sheet 10 is flipped vertically. Specifically, the capacitor sheet 10 is attached (or transferred) to another carrier 6 via the release sheet 7 in an upside-down state.

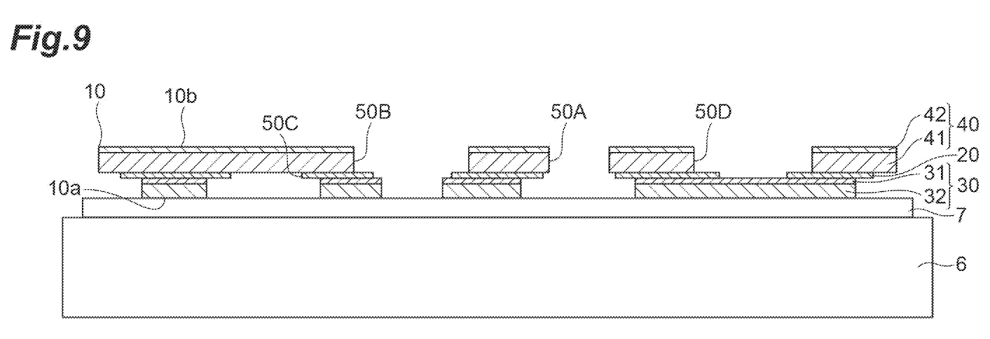

Then, as step S4, as shown in FIG. 9, patterning is performed from the second main surface 10b side by a known photolithography technique and wet etching process to form the second through-hole portion 50B and the recessed portion 50D. The patterning for forming the second through-hole portion 50B is performed in three separate steps in the order of patterning of the second conductor layer 40, patterning of the dielectric layer 20, and patterning of the first conductor layer 30. The patterning for forming the recessed portion 50D is performed in two separate steps: patterning of the second conductor layer 40 and patterning of the dielectric layer 20. At this time, the shape and dimensions of the opening edges are mainly determined by the mask shape, and the inclination angles of the opening edges of the first conductor layer 30, the dielectric layer 20, and the second conductor layer 40 are mainly determined by the etching conditions and layer materials. For example, the inclination angle of the opening edge of the first conductor layer 30, whose main constituent material is Cu which is relatively easy to etch, is larger than the inclination angle of the opening edge of the second conductor layer 40, whose main constituent material is Ni which is more difficult to etch than Cu.

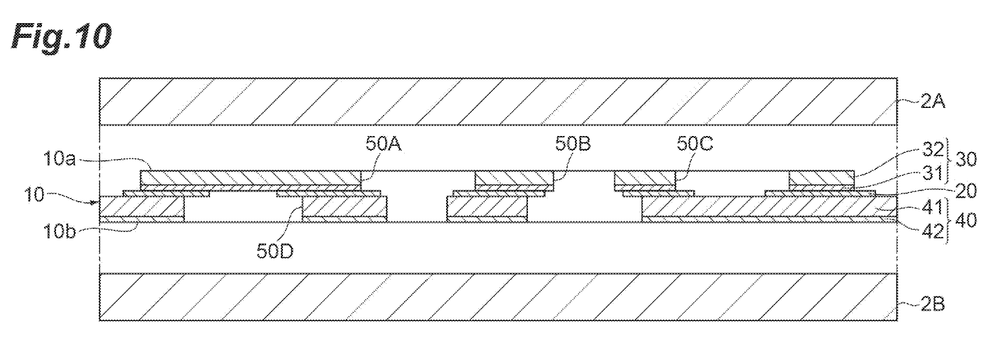

The capacitor sheet 10, which has been patterned from the second main surface 10b side, is peeled off from the carrier 6, turned upside down again as shown in FIG. 10, and as step S5, is sandwiched between resins 2A and 2B that constitute the resin 2 of the capacitor 1. The resin 2B covering the second main surface 10b of the capacitor sheet 10 is, for example, a substrate resin layer that supports the capacitor sheet 10, and the capacitor sheet 10 is mounted in a state where the resin is uncured (or semi-cured). The resin 2A covering the first main surface 10a of the capacitor sheet 10 is, for example, a substrate resin layer placed over the capacitor sheet 10, and is overlaid on the capacitor sheet 10 in a state where the resin is uncured (or semi-cured). Thereafter, the capacitor sheet 10 sandwiched between the resins 2A and 2B is pressed from the thickness direction (the facing direction of the first main surface 10a and the second main surface 10b) and subjected to a curing process.

Finally, as step S6, via conductors 3 to 5 are provided in the resin 2 to complete the capacitor 1 shown in FIG. 1. The via conductors 3 to 5 can be formed by irradiating their respective formation regions with a laser to provide through-holes in the resin 2, and filling the through-holes with a metal such as Cu by plating. For the plating filling, for example, electroless plating and electrolytic plating can be used. Each of the resins 2A and 2B can be composed of a plurality of resin layers, and in this case, laser irradiation and plating filling are performed for each resin layer.

In the above-described capacitor sheet 10, the first through-hole portion 50A is designed such that the width W₃₀ of the opening edge 51 of the first conductor layer 30, the width W₂₀ of the opening edge 52 of the dielectric layer 20, and the width W₄₀ of the opening edge 53 of the second conductor layer 40 decrease in this order, so that the resin 2A from the first main surface 10a side easily flows in during resin pressing (step S5). In particular, in the present embodiment, each of the opening edges 51, 52, and 53 in the first through-hole portion 50A is inclined so as to become narrower as it approaches the second main surface 10b, whereby the resin 2A from the first main surface 10a side flows in more easily. On the other hand, the second through-hole portion 50B is designed such that the width W₃₀ of the opening edge 51 of the first conductor layer 30, the width W₂₀ of the opening edge 52 of the dielectric layer 20, and the width W₄₀ of the opening edge 53 of the second conductor layer 40 increase in this order, so that the resin 2B from the second main surface 10b side easily flows in during resin pressing (step S5). In particular, in the present embodiment, each of the opening edges 51, 52, and 53 in the second through-hole portion 50B is inclined so as to become narrower as it approaches the first main surface 10a, whereby the resin 2B from the second main surface 10b side flows in more easily.

Since the capacitor sheet 10 includes both such a first through-hole portion 50A and a second through-hole portion 50B, when the capacitor sheet 10 is resin-pressed from the facing direction of the first main surface 10a and the second main surface 10b, a stress difference is less likely to occur between the first main surface 10a and the second main surface 10b, and unevenness in the flow of the resins 2A and 2B is less likely to occur. Therefore, in the capacitor sheet 10, the capacitor 1 including the same, and the electronic component 100, high positional accuracy of the capacitor sheet 10 in the capacitor 1 can be realized, and high reliability can be realized.

Note that the capacitor sheet 10 may be provided with a plurality of first through-hole portions 50A and a plurality of second through-hole portions 50B. In this case, the plurality of first through-hole portions 50A and the plurality of second through-hole portions 50B may be arranged so as to be mixed uniformly or non-uniformly. The number of the first through-hole portions 50A and the number of the second through-hole portions 50B provided in the capacitor sheet 10 may be the same or different. The adjacent first through-hole portion 50A and second through-hole portion 50B, when viewed from the facing direction of the first main surface 10a and the second main surface 10b, may be arranged separated by, for example, 200 to 5000 μm (300 μm as an example). The first through-hole portions 50A and the second through-hole portions 50B may be arranged alternately when viewed from the facing direction of the first main surface 10a and the second main surface 10b. The plurality of first through-hole portions 50A and the plurality of second through-hole portions 50B may be arranged in a matrix when viewed from the facing direction of the first main surface 10a and the second main surface 10b.

The present disclosure is not limited to the above-described embodiments and can be variously modified. For example, the capacitor 1 may be an aspect including a plurality of capacitor sheets 10. The cross-sectional shape of the first through-hole portion and the second through-hole portion is not limited to a perfect circle shape, and may be, for example, an elliptical shape, a rectangular shape with rounded corners, a shape with a constriction in an ellipse (for example, a gourd shape), or a shape in which a plurality of perfect circles partially overlap (for example, a figure-eight outer shape).

What is claimed is:

1. A capacitor sheet having a first main surface and a second main surface, comprising:
a capacitance portion having a dielectric layer, a first conductor layer located on the first main surface side and a second conductor layer located on the second main surface side, the dielectric layer is interposed between the first conductor layer and the second conductor layer; and
a plurality of through-hole portions penetrating the capacitance portion,
wherein the plurality of through-hole portions include a first through-hole portion and a second through-hole portion,
wherein, in the first through-hole portion, an opening dimension of the first conductor layer, an opening dimension of the dielectric layer, and an opening dimension of the second conductor layer decrease in this order, and
wherein, in the second through-hole portion, the opening dimension of the first conductor layer, the opening dimension of the dielectric layer, and the opening dimension of the second conductor layer increase in this order.

2. The capacitor sheet according to claim 1, wherein in the first through-hole portion, in a cross-section extending along a facing direction of the first main surface and the second main surface, with respect to an extending direction of the dielectric layer, an opening edge of the dielectric layer extends from an opening edge of the first conductor layer by a distance equal to or greater than a thickness of the dielectric layer.

3. The capacitor sheet according to claim 2, wherein in the first through-hole portion, with respect to the extending direction of the dielectric layer, the opening edge of the dielectric layer is biased toward an opening edge side of the second conductor layer beyond a middle position between the opening edge of the first conductor layer and the opening edge of the second conductor layer.

4. The capacitor sheet according to claim 1, wherein in the second through-hole portion, in a cross-section extending along a facing direction of the first main surface and the second main surface, with respect to an extending direction of the dielectric layer, an opening edge of the dielectric layer extends from an opening edge of the second conductor layer by a distance equal to or greater than a thickness of the dielectric layer.

5. The capacitor sheet according to claim 4, wherein in the second through-hole portion, with respect to the extending direction of the dielectric layer, the opening edge of the dielectric layer is biased toward an opening edge side of the first conductor layer beyond a middle position between the opening edge of the first conductor layer and the opening edge of the second conductor layer.

6. The capacitor sheet according to claim 1, wherein, in the first through-hole portion, an opening edge of the first conductor layer, an opening edge of the dielectric layer, and an opening edge of the second conductor layer are inclined to narrow toward the second main surface, and
wherein, in the second through-hole portion, the opening edge of the first conductor layer, the opening edge of the dielectric layer, and the opening edge of the second conductor layer are inclined to narrow toward the first main surface.

7. The capacitor sheet according to claim 6, wherein in at least one of the first through-hole portion and the second through-hole portion, an inclination angle of the opening edge of the first conductor layer and an inclination angle of the opening edge of the second conductor layer are different.

8. The capacitor sheet according to claim 7, wherein the inclination angle of the opening edge of the second conductor layer is smaller than the inclination angle of the opening edge of the first conductor layer.

9. A capacitor, comprising the capacitor sheet according to claim 1, and a resin covering the first main surface and the second main surface of the capacitor sheet.

10. An electronic component, wherein the capacitor according to claim 9 is mounted.
